(19) United States
(12) Patent Application Publication
(10) Pub. No.: US 2004/0066644 A1
(43) Pub. Date: Apr. 8, 2004

(54) Display device for an instrument board of a vehicle

(76) Inventor: Kao-Yuan Chang, Kaohsiung Hsien (TW)

Correspondence Address: Richard P. Berg, Ladas & Parry, Suite #2100, 5670 Wilshire Boulevard, Los Angeles, CA, 90036-5679, US

(21) Appl. No.: 10/367,532

(22) Filed: Feb. 14, 2003

(30) Foreign Application Priority Data
Oct. 3, 2002 (TW) 091215694

(51) Int. Cl. G01D 11/28

(52) U.S. Cl. 362/23; 362/84

(57) ABSTRACT

A display device is adapted to be mounted on an instrument board, and includes a display unit and a light source. The display unit includes a plate and an indicator pattern provided on the plate. The pattern has a photoluminescent layer applied to the surface thereof. The plate is made of a composite material which is composed of a resinous material and a woven fabric reinforcing the resinous material. The light source is mounted on the instrument board for illuminating the display unit.

### CROSS-REFERENCE TO RELATED APPLICATION

This application claims priority of Taiwanese application No. 091215694, filed on Oct. 3, 2002.

### BACKGROUND OF THE INVENTION

1. Field of the Invention

The invention relates to a display device, more particularly to a display device adapted to be mounted on an instrument board of a vehicle.

2. Description of the Related Art

FIG. 1 illustrates a conventional electroluminescent sheet 1, which is adapted to be mounted on an instrument board of a vehicle. The electroluminescent sheet 1 includes a plurality of indicator patterns 10, and is illuminated through an electrical circuit (not shown). Although the electroluminescent sheet 1 is relatively inexpensive as compared to other conventional display devices for an instrument board of a vehicle, it requires an electric source of high voltage for illuminating. Therefore, it is necessary to install a step-up transformer to generate the voltage for illuminating the electroluminescent sheet 1. However, the step-up transformer will generate noise during operation. Furthermore, since the electroluminescent sheet 1 is activated using electricity, the luminance thereof may be reduced due to a decrease in operating voltage after a period of operation. Additionally, the application of the electroluminescent sheet 0.1 may be limited since it is necessary to configure the electroluminescent sheet 1 for a specific type of instrument board.

### SUMMARY OF THE INVENTION

Therefore, it is an object of the present invention to provide a display device for an instrument board of a vehicle, which has an enhanced display effect and lifetime, which is relatively inexpensive, and which has a broad range of applications.

The display device according to this invention is adapted to be mounted on an instrument board, and includes a display unit and a light source. The display unit includes a plate and an indicator pattern provided on the plate. The pattern has a photoluminescent layer applied to the surface thereof. The plate is made of a composite material which is composed of a resinous material and a woven fabric reinforcing the resinous material. The light source is mounted on the instrument board for illuminating the display unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional electroluminescent sheet for an instrument board of a vehicle;

FIG. 2 is a perspective view of the preferred embodiment of a display device for an instrument board of a vehicle according to this invention;

FIG. 3 is a fragmentary schematic view of the preferred embodiment when applied to the instrument board;

FIG. 4 is a fragmentary schematic sectional view of a display unit of the preferred embodiment;

FIG. 5 is a schematic view of the preferred embodiment in a non-illuminated state; and

FIG. 6 is a schematic view of the preferred embodiment in an illuminated state.

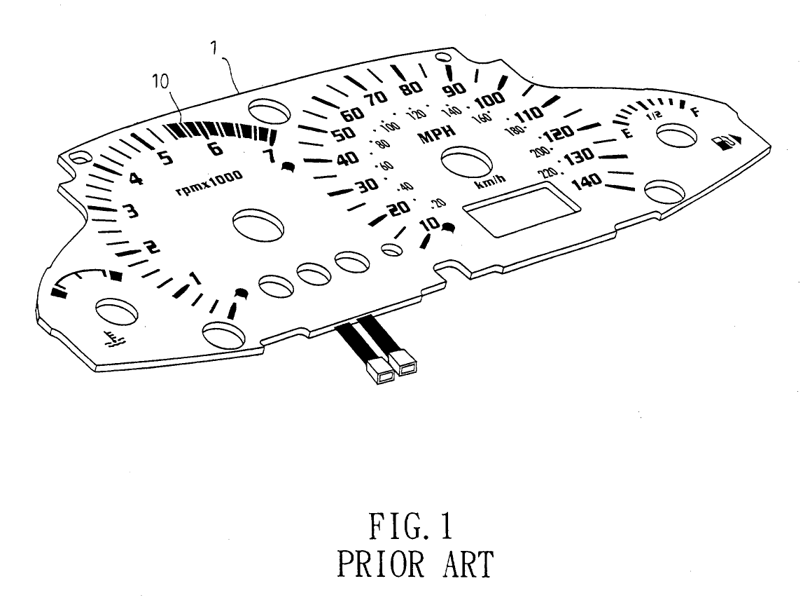

### DETAILED DESCRIPTION OF THE PREFERRED EMBODIMENT

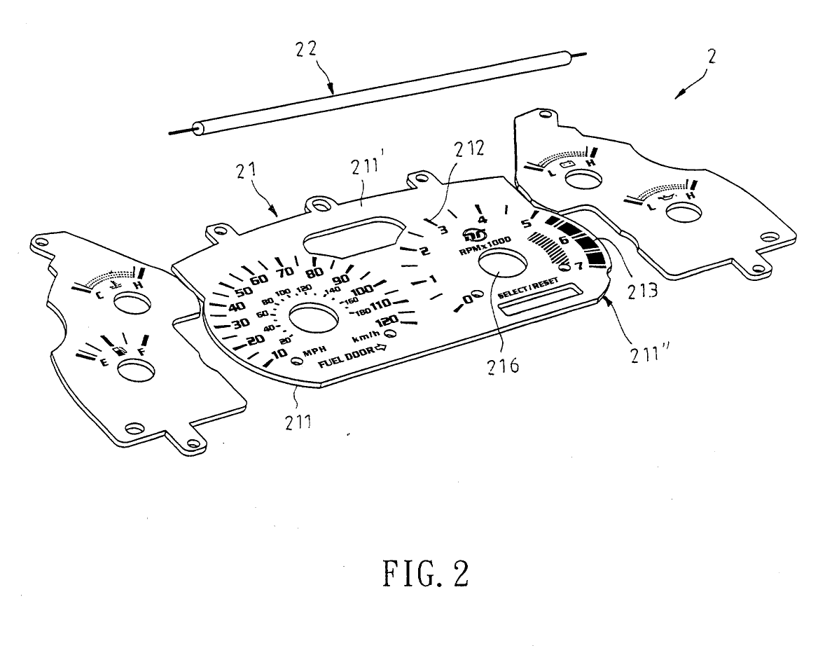

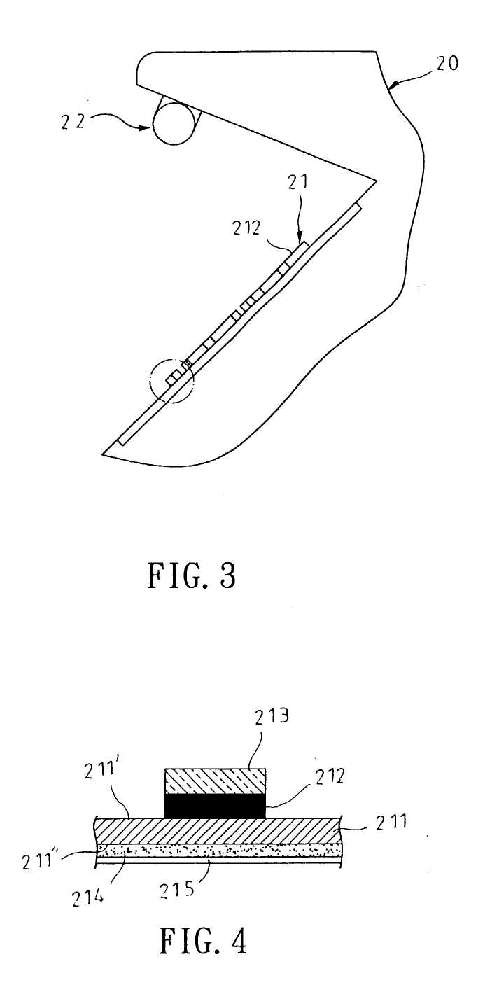

Referring to FIGS. 2 and 3, the preferred embodiment of a display device 2 according to this invention is shown to be mounted on an instrument board 20 of a vehicle. The display device 2 includes a display unit 21 and a light source 22. The display unit 21 includes a plate 211 and an indicator pattern 212 provided on the plate 211. The plate 211 is made of a composite material which is composed of a resinous material and a woven fabric reinforcing the resinous material. The pattern 212 has a photoluminescent layer 213 applied to the surface of the indicator pattern 212 (best shown in FIG. 4). The light source 22 is mounted on the instrument board 20 for illuminating the display unit 21.

Preferably, the light source 22 is an ultraviolet light source, such as an ultraviolet lamp. More preferably, the light source 22 emits ultraviolet light with a wavelength ranging from 300 nm to 400 nm. The wavelength of the ultraviolet light emitted by the ultraviolet light source used in the preferred embodiment is 365 nm. The light source 22 is electrically connected to a controller (not shown), which controls the illumination of the headlight of the vehicle.

Referring again to FIGS. 2 and 4, the photoluminescent layer 213 is a transparent fluorescent material which can emit fluorescent light in response to the ultraviolet light emitted from the ultraviolet light source 22. The photoluminescent layer 213 is formed as a transparent coating layer.

The indicator pattern 212 includes a plurality of graduation marks of a speedometer, a revolution counter, a fuel indicator, a temperature indicator, etc. The graduation marks are arranged in an arcuate pattern and which are spaced apart annularly. The graduation marks are formed from a colored painting material. The photoluminescent layer 213 is transparent and is formed on the painting material.

The plate 211 has a first side 211′ and a second side 211″ opposite to the first side 211′. The graduation marks are provided on the first side 211′. The plate 211 further has an adhesive layer 214 applied to the second side 211″, and a release paper 215 removably attached to the adhesive layer 214. The plate 211 further has a pointer hole 216 for receiving a pointer (not shown) of the instrument board 20 of the vehicle. The graduation marks surround the pointer hole 216.

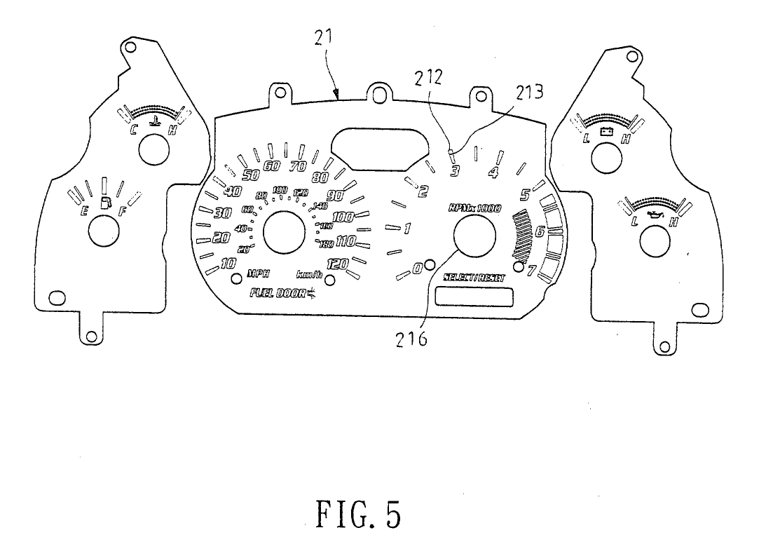

Referring to FIG. 5, during the daytime, since the photoluminescent layer 213 applied on the indicator pattern 212 of the display unit 21 is transparent, the driver can clearly recognize the parameters indicated by the graduation marks of the indicator pattern 212.

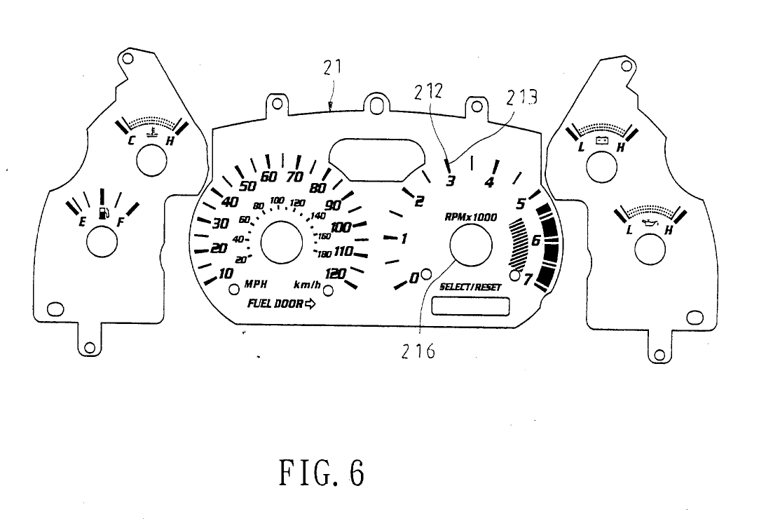

Referring to FIG. 6, when it is required to activate the display device 2, such as during the nighttime, the light source 22 is turned on so that the photoluminescent layer 213 can emit fluorescent light in response to the ultraviolet light emitted from the light source 22. Therefore, the driver can clearly recognize the parameters indicated by the graduation marks of the indicator pattern 212.

In view of the aforesaid, since illumination of the indicator pattern 212 of the display device 2 is conducted through the photoluminescent layer 213 which emits visible light in response to the light emitted from the ultraviolet light source 22, the aforesaid disadvantages of the prior art can be overcome.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A display device adapted to be mounted on an instrument board of a vehicle, comprising:
a display unit including a plate and an indicator pattern provided on said plate, said pattern having a photoluminescent layer applied to the surface thereof, said plate being made of a composite material which is composed of a resinous material and a woven fabric reinforcing said resinous material; and
a light source adapted to be mounted on the instrument board for illuminating said display unit.

2. The display device as claimed in claim 1, wherein said light source is an ultraviolet light source.

3. The display device as claimed in claim 1, wherein said light source emits ultraviolet light with a wavelength ranging from 300 nm to 400 nm.

4. The display device as claimed in claim 2, wherein said photoluminescent layer is a transparent fluorescent material which can emit fluorescent light in response to the ultraviolet light emitted from said ultraviolet light source.

5. The display device as claimed in claim 1, wherein said photoluminescent layer is formed as a transparent coating layer.

6. The display device as claimed in claim 1, wherein said indicator pattern includes a plurality of graduation marks which are arranged in an arcuate pattern and which are spaced apart annularly.

7. The display device as claimed in claim 6, wherein said graduation marks are formed from a colored painting material, said photoluminescent layer being transparent and being formed on said painting material.

8. The display device as claimed in claim 7, wherein said plate has a first side and a second side opposite to said first side, said graduation marks being provided on said first side, said plate further having an adhesive layer applied to said second side, and a release paper removably attached to said adhesive layer, said plate further having a pointer hole adapted to receive a pointer of the instrument board of the vehicle, said graduation marks surrounding said pointer hole.

9. A display device mountable on an instrument board of a vehicle, comprising a display unit including a plate having a first side and a second side opposite to said first side, and an indicator pattern provided on said first side, said indicator pattern including a plurality of graduation marks of a speedometer, and a photoluminescent layer provided on said graduation marks, said plate further having an adhesive layer applied to said second side, and a release paper removably attached to said adhesive layer.

10. The display device as claimed in claim 9, wherein said indicator pattern further includes graduation marks of a revolution counter, graduation marks of a fuel indicator and graduation marks of a temperature indicator.
